(19) United States
(12) Patent Application Publication
(10) Pub. No.: US 2006/0205431 A1
(43) Pub. Date: Sep. 14, 2006

(54) Electronic device having multiple modes of operation

(75) Inventor: Robert C. Newstead, Surrey (GB)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/187,311

(22) Filed: Jul. 23, 2005

(30) Foreign Application Priority Data
Mar. 10, 2005 (GB) 0504920.0

(51) Int. Cl. H04M 1/00

(52) U.S. Cl. 455/550.1

(57) ABSTRACT

The present invention provides an electronic device having a plurality of different user-selectable modes, each mode for performing a different function of the electronic device. The device can include a help mode in which the keys of the device are illuminated to distinguish a given set of keys associated with operation of the device in each mode from the remaining keys of the electronic device to teach the use if the selected mode of the device to the user.

### FIELD OF THE INVENTION

The present invention relates to the field of electronic devices having a plurality of different user-selectable functional modes, each mode performing a different function of the electronic device.

### BACKGROUND TO THE INVENTION

One example of such an electronic device is a mobile telephone. In this case, the modes may include, but are not limited to, a camera function, a phone function, a diary function, a calendar function, and an address book function.

Typically the camera function allows a user to take and store photographs/video images. It may also allow the user to edit the photographs/video/images or transmit the photographs/video images electronically to another electronic device.

The phone function allows a user to make and receive telephone calls. The phone function may also permit a user to manage calls as well as providing information relating to call duration and/or cost.

The calendar function often allows a user to store useful dates such as birthdays and other anniversaries. It may also provide a user with a reminder of important appointments.

A user normally uses the address book function to store the contact details of family, friends and colleagues, thereby allowing the easy retrieval of, for example, a person's telephone number when wishing to telephone them.

One or more modes may be performed from within another mode. For example, from within the address book function, a phone call may be made to a particular number by selecting the particular number from an associated contact in the address book.

U.S. Pat. No. 6,010,339 discloses a toy telephone operable in a first mode which illuminates buttons 0 to 9 in a sequence corresponding to a telephone number. A child user attempts to push each button as the button is illuminated, thereby being directed to learn the number and position of each button within a keypad. In this way the toy is a learning aid for the keypad arrangement found in a conventional telephone. The toy telephone is also operable in a second mode to teach the child user his home telephone number. However, both modes perform the same functionality, i.e. illuminating buttons 0 to 9 in a sequence corresponding to a particular telephone number.

Modern electronic devices, such as mobile telephones, include a combination of different functional modes. A user is able to select a particular mode according to the function he wishes to perform. In addition, each mode may include a number of different sub-functions, with each function and sub-function being operated by particular keystrokes or a sequence of keystrokes. As a result, a user normally has to learn a large number of keystroke and key sequence combinations in order to operate a myriad of different functions and sub-functions.

The conflicting demands on a user's time often mean that a user, when purchasing a new electronic device, does not have the time or the inclination to refer to a user manual in order to learn a particular function. Consequently, many advanced or particularly advantageous features of the telephone go un-noticed.

### SUMMARY OF THE PRESENT INVENTION

The present invention provides an electronic device having a plurality of different user-selectable modes, each mode for performing a different function of the electronic device, the electronic device comprising:
a user interface having a plurality of keys, a given set of the plurality of keys being associated with the operation of the device in each mode;
a light source arranged to illuminate one or more keys, and
a processor configured to control the illumination of the plurality of keys, and wherein the processor is configured to illuminate a given set of keys corresponding to a user-selected mode to distinguish the given set of keys from the remaining keys of the user interface, and wherein the device is arranged to comprise a help mode to illuminate the given set of keys associated with a user-selected mode in the help mode to teach the use of the user-selected mode.

The ability to illuminate a given set of keys that correspond to a particular mode means that the device indicates to a user the keys required to operate a given mode, thereby excluding from the user's consideration those keys that are not usable in a given mode.

Indicating the operative keys in this way in the help mode acts as a teaching/training aid, which visually instructs a user as to how to operate the device so as to carry out the functions of the electronic device, thereby facilitating the quick and easy learning of how to operate a particular mode.

For example, if a user wishes to take a photograph then the device is able to illuminate only those keys that are applicable to the camera function.

The device may be arranged to turn on/off the help mode. The help mode may be arranged to allow the electronic device to perform the user-selected functions. The help mode may be arranged to preclude the device from performing the user-selected functions.

The help mode may comprise a first help mode and a second help mode, wherein the first help mode is arranged to allow the electronic device to perform the user-selected functions, and wherein the second help mode is arranged to preclude the device from performing the user-selected functions.

The device may comprise a display, wherein the device is arranged to teach the use of a selected mode by a combination of information provided on the display and the illumination of a given set of keys associated with the function of the selected mode. Audio may be used to aid the teaching. Audio may be used in conjunction with the display or independently of the display to provide the teaching.

The processor may be arranged to illuminate the plurality of keys regardless of an association of a given set of keys with a particular user-selected mode. This may or may not be when the device in help mode. The processor may be arranged to provide illumination to the plurality of keys after an unlocking operation detected by the processor for the plurality of the keys.

The processor may be arranged to deactivate illumination of the plurality of keys and activate illumination of a given set of keys corresponding to a user-selected mode upon selection of the user-selected mode by a user.

The processor may be arranged to illuminate the given set of keys corresponding to a user-selected mode in a single colour. The processor may be arranged to illuminate the given set of keys corresponding to a user-selected mode in different colours.

The processor may be arranged to vary the duration of the illumination of one or more of the given set of keys corresponding to a user-selected mode.

The processor may be arranged to vary the intensity of the illumination of one or more of the given set of keys corresponding to a user-selected mode.

The processor may be arranged to deactivate illumination of a first given set of keys corresponding to a first particular user-selected mode and activate illumination of a second given set of keys corresponding to a second user-selected mode upon selection of the second user-selected mode by a user.

The processor may be arranged to provide constant illumination to one or more keys of a given set of keys corresponding to a user-selected mode over the time period that the mode is selected by a user.

The processor may be arranged to intermittently illuminate one or more keys of a given set of keys corresponding to a user-selected mode over the time period that the mode is selected by a user.

The processor may be arranged to sequentially illuminate one or more keys of the given set of keys corresponding to a user-selected mode, the sequential illumination of the keys corresponding to the keystroke sequence required to activate a particular function of the user-selected mode.

The processor may be arranged to illuminate a particular subset of the given set of keys corresponding to a user-selected mode differently to the other keys of the given set of keys, the subset of the keys corresponding to a particular sub-function of the user-selected mode. The processor may be arranged to use one or more different colours for the subset of the given set of keys to the colour(s) used for the remaining keys of the given set of keys corresponding to a user-selected mode.

The processor may be arranged to illuminate a first given set of keys corresponding to a first user-selected mode in one colour and a second given set of keys corresponding to a second user-selected mode in a different colour.

The device may comprise one or more common keys which are for use in a plurality of user-selected modes, and wherein the device is arranged to provide illumination to one or more common keys using a single multicolour light source. One or more common keys may be illuminated by one or more multicolour LEDs.

The device may comprise a single light source for each key.

The device may comprise a common light source for a group of the plurality of keys. The device may comprise a common light source for a given set of keys for one or more user-selected modes. The device may comprise a common light source for a given sub-set of keys for one or more user-selected modes.

One or more keys may be comprised on a display of the device. The device may comprise mobile phone functionality. The light source may comprise one or more LEDs.

The modes may comprise a camera function, a phone function, a diary function, a calendar function, and an address book function.

The invention encompasses an appropriately adapted user interface. One or more embodiments of the invention may be appropriately combined in various combinations. The invention also encompasses corresponding methods of operating a user interface/electronic device.

### BRIEF DESCRIPTION OF THE FIGURES

There now follows a brief description of a preferred embodiment of the invention, by way of non-limiting example, with reference being made to the accompanying drawing, in which:

FIG. 1 shows a perspective view of an electronic device according to a first embodiment of the invention; and

FIG. 2 shows a schematic representation of the electronic components of the electronic device shown in FIG. 1.

### DETAILED DESCRIPTION OF SPECIFIC EMBODIMENTS

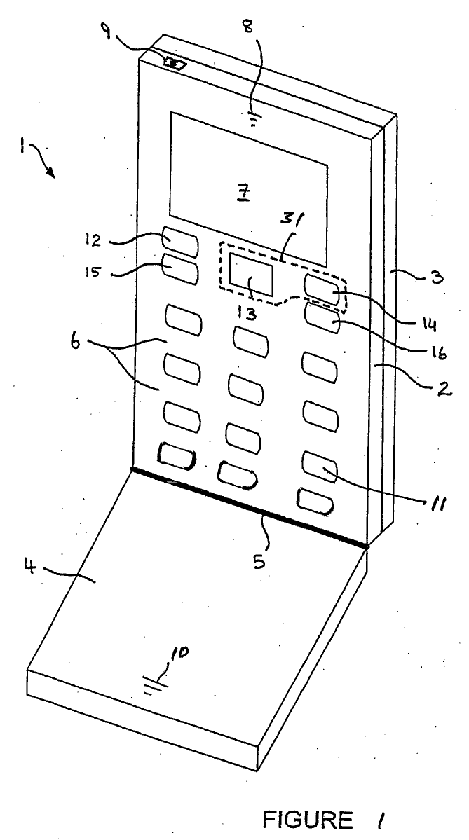

The exterior details of an electronic device, specifically a mobile telephone 1, are shown in FIG. 1.

The telephone 1 of FIG. 1 is of a “flip-type” construction and has a front casing portion 2, a rear casing portion 3 and a cover 4 pivotally connected to the front casing portion 2 which is movable between a closed position in which it overlies the casing 2 and an open position in which it extends away from the front casing portion 2. The pivotal connection could be any hinge arrangement. However, in the embodiment shown in FIG. 1, the angle to which the cover 4 extends relative to the casing 2 is dependent on the length of a flexible member 5, formed from a strip of rubber or polymer material joining the front casing 2 to the cover 4.

In FIG. 1, the cover 4 is shown in an almost completely open position. A user interface is provided in the front casing portion 2 and comprises a keypad 6, an electronic display 7, an ear-piece 8, and an on/off key 9. A microphone 10 is fitted in the cover 4. The rear casing portion 3 has a removable portion (not shown) to enable internal housing of a memory/IC card e.g. a SIM card and/or memory card. The telephone 1 is adapted to enable communication via a wireless telecommunications network, e.g. a cellular network. However, the telephone 1 could also be designed for a cordless network or any other transmission network.

The keypad 6 has a first group of alphanumeric keys 11. These allow alphanumeric input to enable a user to enter a telephone number, write a text message (SMS) or enter a name associated with a particular number, etc.

The keypad 6 additionally includes five soft keys 12,13,14,15, and 16, which change function depending on the status of the telephone 1. The first soft key 12 is used to access the menu structure and to select a functional mode from the menu. The second soft key 13 is used to scroll up and down in the display 7 whilst a menu is displayed. The third soft key 14 is used to enter the phonebook options when the telephone 1 is in a standby position. However, when in the menu structure, the third soft key 14 is used to close the menu structure or erase entered characters. The fourth and fifth soft keys 15,16 are call-handling keys. The first call-handling key 15 is used to start a call or establish a conference call and the second call-handling key 16 is used to end a conference call or reject an incoming call.

The keys 11-16 of the keypad 6 shown in FIG. 1 can each be lit from within/underneath by one or more LEDs (not shown in FIG. 1), as with the Nokia 7610. In other embodiments, the telephone 1 may be configured to illuminate a region around each of the keys 11, 12, 13,14, 15, 16.

It may be that the LED for one or more keys may only emit light of a single predetermined colour (corresponding to one particular wavelength). However, in the embodiment of FIG. 1, the LED for one or or more keys emits light of more than one colour (corresponding to a number of different wavelengths) i.e. a telephone in which one or more keys are illuminated by a multicolour LED.

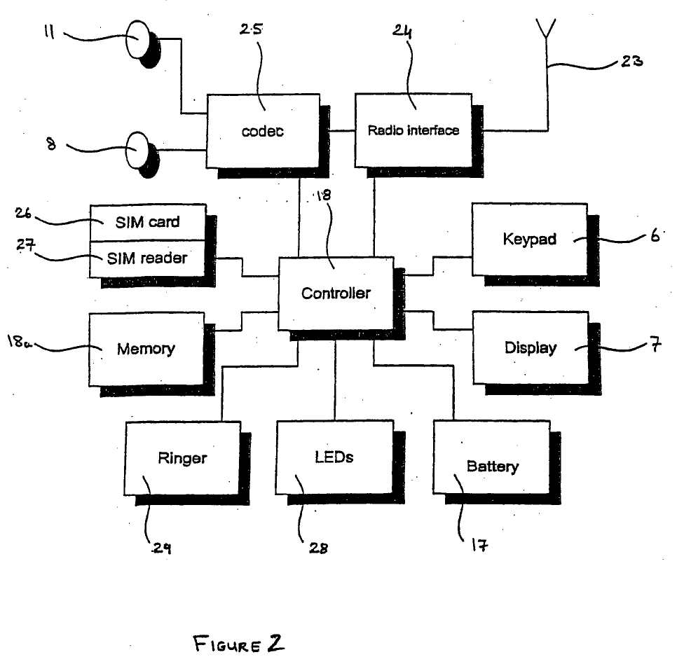

FIG. 2 shows a schematic representation of the main components of the mobile telephone illustrated in FIG. 1. The telephone 1 is powered by a removable battery pack 17. The telephone 1 also includes a subscriber identification module (SIM) card 26, a SIM card reader 27, light emitting diodes (LEDs) 28 and a ringer 29. The individual circuits and elements are of a type well known in the art, for example, in the Nokia range of mobile telephones.

Signal processing is carried out under the control of a digital microcontroller 18 that has an associated RAM/ROM and flash memory 18a. The controller 18 receives instruction signals from the keypad 6 including the soft keys 12,13,14,15,16 and controls the operation of the display 7. Radio signals are transmitted and received by means of an antenna 23 connected through a radio interface 24 to a codec 25 configured to process signals under control of the controller 18.

Thus, in use, for speech, the codec 25 receives analogue signals from the microphone 10, digitises them into a form suitable for transmission and feeds them to the radio interface 24 for transmission through antenna element 23 to the public land mobile network (PLMN). Similarly, received signals are fed to codec 25 so as to produce analogue signals that are fed to the ear-piece 8.

As mentioned above, the telephone 1 has a plurality of different functional modes that are user-selectable from the menu. However, in other embodiments, one or more dedicated keys may be provided to provide selection of a particular mode e.g. a dedicated key which is arranged to activate the camera mode of the phone when it is pressed. This dedicated selection can be regardless of the position within the menu structure of the operating system of the telephone 1 i.e. regardless of whether the telephone 1 is within one mode or, for example, is at the start position of the menu structure.

Each mode performs a different function of the telephone 1. In the case of the telephone 1, the modes provide a camera function, a phone function, a diary function, a calendar function and an address book function.

A given set of alphanumeric keys 11 and soft keys 12, 13, 14, 15, 16 is associated with the operation of the device in each mode. For example, in the camera mode the fourth soft key 14 may be used to take a photograph, while the second soft key 13 may be used to scroll through stored photographic images. Soft keys 13 and 14 therefore define a first given set of keys 31, as shown by the dotted line, which are associated with the camera mode.

In a conventional manner, the telephone 1 is arranged to allow the LEDs 28 to illuminate all the keys (the alphanumeric and soft keys 11, 12, 13,14, 15, 16) at the same time. This will allow better visualisation of the keypad 6 during low light conditions. This functionality may be selectively turned on/off. The illumination of all of the keys, all of the time, would waste battery power, and thus the illumination of all the keys may occur only after depression of one or more keys (e.g. after the keypad 6 has been unlocked), as is conventional.

In contrast to the above-mentioned conventional manner, the telephone 1 is configured to be able highlight (e.g. illuminate) a given set of keys associated with a particular mode function over the rest of the keys not associated with that function. For example, the given set of keys 31, corresponding to the selected camera mode, are illuminated to contrast over the remaining keys of the keypad 6. The illumination distinguishes the given set of keys 31 from the other keys of the keypad 6.

The highlighting may take various forms as discussed in more detail below. However, in general, it may simply be illumination using a single colour, or illumination using a number of different colours. The duration and or intensity of the illumination to one or more given keys may change or be constant. In the embodiment of FIG. 1, one or more various forms of highlighting can be selected by a user. However, the telephone may be configured to not allow a user to choose between various highlighting forms.

Various embodiments detailing different forms of illumination highlighting will now be described with particular reference to the camera mode.

In one embodiment, when the telephone 1 is in the camera mode, the telephone 1 illuminates all of the given set of keys 31 and leaves the other keys unlit. This may require turning off of previously lit keys e.g. if all the keys were previously lit after unlocking of the keypad, or if different given keys are appropriate for the newly selected camera mode.

In one embodiment of the telephone 1 of FIG. 1, the telephone 1 is arranged to constantly illuminate each of the given set of keys over the highlighting time period. In other embodiments of the invention, the telephone 1 is arranged to illuminate each key intermittently during the period in which it is highlighted. In this way, the given set of keys are seen by a user to flash.

The given set of keys may be individually turned on and off in sequence to highlight the given set of keys over the other keys. Moreover, where it is necessary to perform a series of keystrokes in order to operate a particular camera function, the telephone 1 can illuminate the given set of keys sequentially in the order in which it is necessary to operate them to perform the particular camera function.

It may be that two or more keys may be actuatable within a particular series of keystrokes to perform different functions. For example, once camera mode has been selected, one key could perform a zoom in operation and another key could perform a zoom out operation. Both these zooming keys may be illuminated simultaneously (for example, in different colours).

If only some, and not all, of the given keys are associated with a particular sub-function, then those keys of the given set of keys that perform the particular sub-function are highlighted differently to the other given keys. For example, if four keys in total can be used in the camera mode, one of the keys allowing cancelling of the selected camera mode operation, two of the keys allowing zoom operations and the remaining key allowing the capture of an image, then the zoom and the capture keys can be highlighted differently to the cancel key. The zoom keys may also be highlighted differently to the capture key.

As previously indicated, colour may be used to highlight the given set of keys. All the given set of keys of one mode may be associated with illumination in the same one colour. For example, all the camera keys can be lit by a blue light.

Different colours can be used in the same mode to distinguish between subsets of the given keys i.e. to identify those sub-group of keys that perform a particular sub-function e.g. zoom function. One subset of keys may be illuminated in one colour, and a different subset of keys in a different colour.

Different colours can be used for different modes. For example, the set of keys 31 associated with the camera function can be illuminated in a green colour. The set of keys (not shown) associated with the phone functions can be illuminated in a blue colour.

There may be one or more common keys in the given sets of keys used in different modes. Thus, a key used in one mode is not dedicated for use in that mode only. The colour of such a common key could therefore change dependent on the mode. A multicolour LED would be particularly useful for such common keys.

A single light source (e.g. LED) may be provided for each key of the keypad 6. However, rather than having a single light source (e.g. LED) for each key, a group of keys can have a common light source i.e. a single LED can be arranged to supply light to a number of different keys.

Advantageously, a common light source (e.g. a common LED) may be associated with providing illumination for a given set of keys for a particular selected mode. So for example, all (or most) of the keys usable in the camera mode can be supplied with illumination from a common LED.

In the case that a given key is used in a multiple number of modes, then it would be advantageous to have a specific light source (e.g. LED) for that given key. Thus, this key can be individually activated in a number of different modes without having to unnecessarily illuminate an adjacent key which is not used in one of the multiple modes in which the given key can be used. The use of a multicolour LED for such multiple mode given keys would be beneficial.

The telephone 1 may also include a help mode. This is user-selectable so that the mode can be turned on/off.

The help mode may be used in conjunction with normal operation of the telephone so that the telephone can be used to perform the required functions. However, the help mode may preclude normal operation of the telephone 1 by demonstration of the functionality.

The help mode can include a number of different teach mode options, which can be selected to teach the use of an associated mode. When one of the teach modes is selected, the user can be taught the functionality of that mode by a combination of information provided on the display and the selected illumination of a given set of keys associated with the functions of the mode. The telephone 1 may provide voice commands to help with the tuition.

It will be appreciated that, in general, the present invention provides that, in use, the user is taught how to operate the telephone 1 by the selective illumination of a given set of keys according to a user-selected functional mode of the telephone 1.

Various modifications can be made without departing from the scope of the present invention. For example, an electroluminescent panel may be used as a light source for key illumination. The keys may be touch sensitive, and/or be comprised on the display 7 rather than being on a separate keypad. A key can comprise different portions such that, for example, one portion provides scrolling to the left, another scrolling to the right, another scrolling up, another scrolling down, another selection etc i.e. each portion provides actuation of a different command. Different shades of an illumination colour may be used. For example, various camera sub-functions may be illuminated using a light green, mid green and dark green colour, respectively.

The invention also encompasses software arranged to perform the particular illumination/highlighting functions as described. One or more embodiments of the invention in combination are also within the scope of the present invention.

1. An electronic device having a plurality of different user-selectable modes, each mode for performing a different function of the electronic device, the electronic device comprising:
a user interface having a plurality of keys, a given set of the plurality of keys being associated with the operation of the device in each mode;
a light source arranged to illuminate one or more keys, and
a processor configured to control the illumination of the plurality of keys, and wherein the processor is configured to illuminate a given set of keys corresponding to a user-selected mode to distinguish the given set of keys from the remaining keys of the user interface, and wherein the device is arranged to comprise a help mode to illuminate the given set of keys associated with a user-selected mode in the help mode to teach the use of the user-selected mode.

2. A device according to claim 1, wherein the device is arranged to provide a user-selectable help mode that can be turned on/off.

3. A device according to claim 1, wherein the help mode is arranged to allow the electronic device to perform the user-selected functions.

4. A device according to claim 1, wherein the help mode is arranged to preclude the device from performing the user-selected functions.

5. A device according to claim 1, wherein the help mode comprises a first help mode and a second help mode, wherein the first help mode is arranged to allow the electronic device to perform the user-selected functions, and wherein the second help mode is arranged to preclude the device from performing the user-selected functions.

6. An electronic device according to claim 1, wherein the device comprises a display, and wherein the device is arranged to teach the use of a selected mode by a combination of information provided on the display and the illumination of a given set of keys associated with the function of the selected mode.

7. An electronic device according to claim 1, wherein the device comprises audio output arranged to teach the use of a selected mode by a combination of audio and the illumination of a given set of keys associated with the function of the selected mode.

8. An electronic device according to claim 1, wherein the device comprises mobile phone functionality.

9. An electronic device according to claim 1, wherein the modes comprise at least one of the functions selected from the list of a camera function, a phone function, a diary function, a calendar function, and an address book function.

10. An electronic device according to claim 1, wherein the modes comprise a camera function, a phone function, a diary function, a calendar function, and an address book function.

11. An electronic device according to claim 1, wherein the processor is arranged to illuminate the plurality of keys regardless of an association of a given set of keys with a particular user-selected mode.

12. An electronic device according to claim 11, wherein the processor is arranged to provide illumination to the plurality of keys after an unlocking operation detected by the processor for the plurality of the keys.

13. An electronic device according to claim 11, wherein the processor is arranged to deactivate illumination of the plurality of keys and active illumination of a given set of keys corresponding to a user-selected mode upon selection of the user-selected mode by a user.

14. An electronic device according to claim 1, wherein the processor is arranged to illuminate the given set of keys corresponding to a user-selected mode in a single colour.

15. An electronic device according to claim 1, wherein the processor is arranged to illuminate the given set of keys corresponding to a user-selected mode in different colours.

16. An electronic device according to claim 1, wherein the processor is arranged to vary the duration of the illumination of one or more of the given set of keys corresponding to a user-selected mode.

17. An electronic device according to claim 1, wherein the processor is arranged to vary the intensity of the illumination of one or more of the given set of keys corresponding to a user-selected mode.

18. An electronic device according to claim 1, wherein the processor is arranged to deactivate illumination of a first given set of keys corresponding to a first particular user-selected mode and activate illumination of a second given set of keys corresponding to a second user-selected mode upon selection of the second user-selected mode by a user.

19. An electronic device according to claim 1, wherein the processor is arranged to provide constant illumination to one or more keys of a given set of keys corresponding to a user-selected mode over the time period that the mode is selected by a user.

20. An electronic device according to claim 1, wherein the processor is arranged to intermittently illuminate one or more keys of a given set of keys corresponding to a user-selected mode over the time period that the mode is selected by a user.

21. An electronic device according to claim 1, wherein the processor is arranged to sequentially illuminate one or more keys of the given set of keys corresponding to a user-selected mode, the sequential illumination of the keys corresponding to the keystroke sequence required to activate a particular function of the user-selected mode.

22. An electronic device according to claim 1, wherein the processor is arranged to illuminate a particular subset of the plurality of keys corresponding to a user-selected mode differently to the other keys of the plurality of keys, the subset of the keys corresponding to a particular sub-function of the user-selected mode.

23. An electronic device according to claim 1, wherein the processor is arranged to illuminate a particular subset of the given set of keys corresponding to a user-selected mode differently to the other keys of the given set of keys, the subset of the keys corresponding to a particular sub-function of the user-selected mode.

24. An electronic device according to claim 23, wherein the processor is arranged to use one or more different colours for the subset of the given set of keys to the colour(s) used for the remaining keys of the given set of keys corresponding to a user-selected mode.

25. An electronic device according to claim 1, wherein the processor is arranged to illuminate a first given set of keys corresponding to a first user-selected mode in one colour and a second given set of keys corresponding to a second user-selected mode in a different colour.

26. An electronic device according to claim 1, wherein the device comprises one or more common keys which are for use in a plurality of user-selected modes, and wherein the device is arranged to provide illumination to one or more common keys using a single multicolour light source.

27. An electronic device according to claim 26, wherein one or more common keys are illuminated by one or more multicolour LEDs.

28. An electronic device according to claim 1, wherein the device comprises a single light source for each key.

29. An electronic device according to claim 1, wherein the device comprises a common light source for a group of the plurality of keys.

30. An electronic device according to claim 1, wherein the device comprises a common light source for a given set of keys for one or more user-selected modes.

31. An electronic device according to claim 1, wherein the device comprises a common light source for a given sub-set of keys for one or more user-selected modes.

32. An electronic device according to claim 1, wherein the one or more keys are comprised on a display of the device.

33. An electronic device according to claim 1, wherein the light source comprises one or more LEDs.

34. A user interface having a plurality of different user-selectable modes, each mode for performing a different function, the user interface comprising:
a plurality of keys, a given set of the plurality of keys being associated with operation in each mode;
a light source arranged to illuminate one or more keys, and
a processor configured to control the illumination of the plurality of keys, and wherein the processor is configured to illuminate a given set of keys corresponding to a user-selected mode to distinguish the given set of keys from the remaining keys of the user interface, and wherein the user interface is arranged to comprise a help mode to illuminate the given set of keys associated with a user-selected mode in the help mode to teach the use of the user-selected mode.
